(19) United States
(12) Patent Application Publication
(10) Pub. No.: US 2006/0137664 A1
(43) Pub. Date: Jun. 29, 2006

(54) Supercharger

(76) Inventor: Todd Allan McCoy, Mesa, AZ (US)

Correspondence Address: ETHERTON LAW GROUP, LLC, 5555 E. VAN BUREN STREET, SUITE 100, PHOENIX, AZ, 85008, US

(21) Appl. No.: 11/022,170

(22) Filed: Dec. 23, 2004

(51) Int. Cl. F02B 33/00

(52) U.S. Cl. 123/565; 123/559.1

(57) ABSTRACT

An electrically powered supercharger having a battery powered motor driving a fan that forces air from an air inlet to an air outlet and hence to an air-fuel intake (such as a carburetor) of an internal combustion engine. The electric motor operates independently of the operation of the internal combustion engine.

### FIELD OF THE INVENTION

The present invention generally relates to internal combustion engines, and to supercharger systems for increasing the torque output of the engine. In particular, it relates to a supercharger for an internal combustion (IC) engine of a remote-controlled (RC) vehicle.

### BACKGROUND OF THE INVENTION

It is known to increase the torque output of an IC engine by increasing the mass air flow into the combustion chamber. This allows a greater fuel-air charge to be delivered to the combustion charger and therefore a greater energy to be generated at each combustion event. Two basic types of boosters are known: turbochargers and superchargers. Both use rotating fans to force air into the inlet manifold. For conventional carbureted engines the fan is located at the air intake to the carburetor. For fuel injected engines the air is forced directly into the inlet manifold.

A turbocharger is driven by the exhaust gases from the IC engine which are redirected to drive a fan that boosts the charge of air being delivered to the fuel delivery manifold. It is well understood that the boost is not available at low engine speeds because insufficient exhaust gas pressure is generated to drive the turbocharger fan at an effective velocity to generate a discernible torque boost.

A supercharger is normally driven by a belt off the crankshaft or flywheel. This arrangement means that the supercharger speed is directly proportional to the engine speed. As with the turbocharger, this means that the supercharger is less effective at low engine speeds.

It is known, for example U.S. patent application No. 2003/0110771, to decouple the operation of the supercharger from the engine speed. This is done to overcome the problem of ineffective torque boost at low engine speeds. The patent application describes an electrically driven supercharger that is powered by a battery. Because the current demands of a supercharger are relatively large a typical car battery is quickly drained during unconstrained operation. The patent application describes a complex control system that constrains the operation of the supercharger within the electrical capacity of the system. Because the supercharger is restricted to operate within allowable limits the problem of energy availability is reduced. Unfortunately, this also means that the supercharger is only available across a limited operating range. The application includes a performance curve that shows operation of the supercharger in the range from 1000 rpm to 3500 rpm and restricted operation from 3500 rpm to 5500 rpm. The supercharger does not operate below 1000 rpm or above 5500 rpm.

Some of the technology described above for automobile IC engines can also be applied to smaller IC engines for RC vehicles. RC vehicles are scaled down versions of real life vehicles. Various engine performance technologies have been applied to RC vehicle engines with inventive modification. One example is a fuel injection system for a single-piston internal combustion engine as described in U.S. Pat. No. 5,896,845 assigned to Futaba Denshi Kogyo KK. Another example is a remote control starter described in U.S. Pat. No. 5,095,865, in the name of Keister.

It is also known to fit a supercharger to an internal combustion engine for remote control vehicles. The known superchargers for remote control vehicles are belt driven from the internal combustion engine and only operate effectively once the engine is up to speed. A typical device is viewable at www.rbinnovations.com.

### SUMMARY OF THE INVENTION

The present invention is an electrically powered supercharger for an internal combustion engine of a remote controlled car that operates independently of the operation of the engine. In one form the invention resides in a supercharger comprising an electric motor for driving a fan mounted in a the housing; an air inlet and an air outlet formed in the housing such that air is urged from the inlet to the outlet by the fan; and means for controlling the operation of the fan independently of the operation of the internal combustion engine.

In a further form the invention resides in a supercharged internal combustion engine for a remote controlled vehicle comprising an internal combustion engine; and a supercharger delivering air to the inlet manifold under pressure. The supercharger comprises a housing; a fan located within the housing; an electric motor for driving the fan mounted to the housing; an air inlet and an air outlet formed in the housing such that air is urged from the inlet to the outlet by the fan; and means for controlling the operation of the fan independently of the operation of the engine.

In another form, the invention resides in a method of operating a supercharger on an internal combustion engine for a remote control vehicle including the steps of:

These and other features and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

In the following detailed description, reference will be made to the attached drawings in which:

FIG. 1 shows an internal combustion engine for a remote control vehicle, fitted with a supercharger;

FIG. 2 shows the supercharger of FIG. 1.;

FIG. 3 is a partially exploded view of the supercharger of FIG. 1;

FIG. 4 is a rear view of the supercharger without air filter or connector tube;

FIG. 5 shows a fan propeller for the supercharger;

FIG. 6 shows the fan housing of the supercharger of FIG. 1;

FIG. 7 shows the air inlet cone of the supercharger of FIG. 1;

FIG. 8 shows a modified connector tube;

FIG. 9 shows a first embodiment of a control system for the supercharger;

FIG. 10 shows a second embodiment of a control system for the supercharger; and

FIG. 11 shows a third embodiment of a control system for the supercharger.

### DETAILED DESCRIPTION OF THE INVENTION

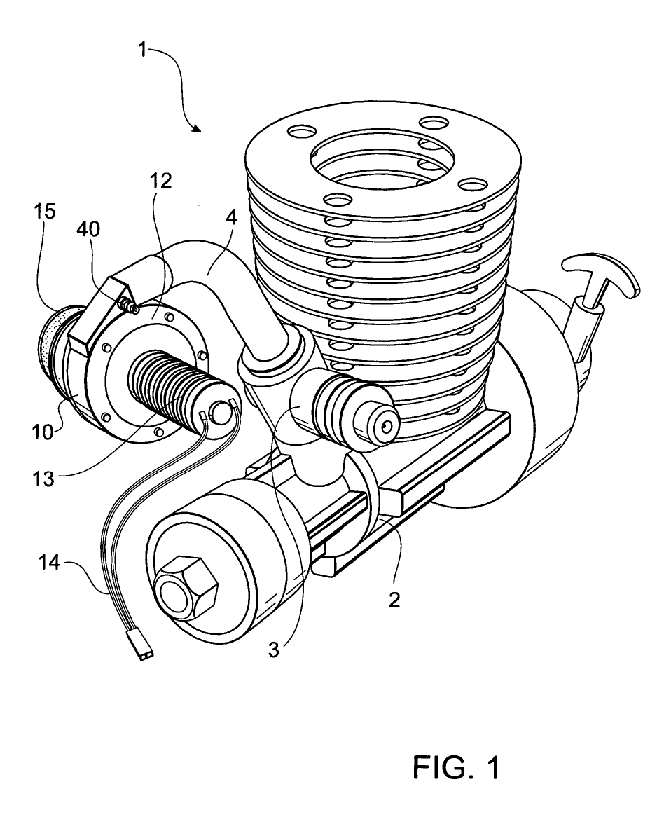

Referring to FIG. 1 there is shown a supercharger 1 fitted to an internal combustion (IC) engine 2, such as the type used for remote control model vehicles. The internal combustion engine is a single cylinder, pull-start engine, used commonly in remote control cars, helicopters and airplanes. The pull starter may be replaced by an electric starter on some engines.

The supercharger 1 forces air into a carburetor 3 through connection tube 4. It is conveniently mounted to the carburetor with connector tube 4. A mounting plate may be used, if desired; other forms of mounting will be needed for other engines and will be within the knowledge of persons skilled in the field.

For ease of explanation the discussion and drawings refer to a conventional internal combustion engine employing a throttled carburetor. As mentioned above, it is known to employ fuel injection on internal combustion engines for remote control vehicles. The supercharger 1 is still suitable for fuel injected engines but the supercharger delivers air directly to an inlet manifold before fuel is injected to form the fuel-air mix.

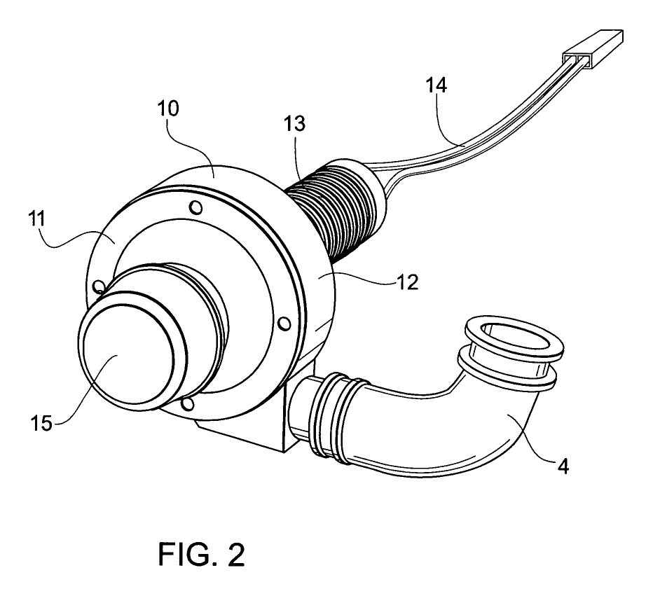

See FIGS. 1-8. The supercharger 1 comprises a housing 10. The housing 10 is suitably formed in two parts including an inlet cone 11 and a fan chamber 12. An electric motor 13 is powered by a battery (not shown) via power leads 14. Air enters the inlet cone 11 through air filter 15 and is discharged under pressure through connector tube 4 and hence into the carburetor 3. A fan propeller 20 is located in the fan chamber 12 and driven by the motor 13.

The motor 13 is suitably fitted to the housing 10 through an aperture 30 in the fan chamber 12, and held in place by a screw 31. It will be appreciated that this is only one way to attach the motor 13 to the housing 10, numerous other methods would be suitable, such as a threaded or compression fit.

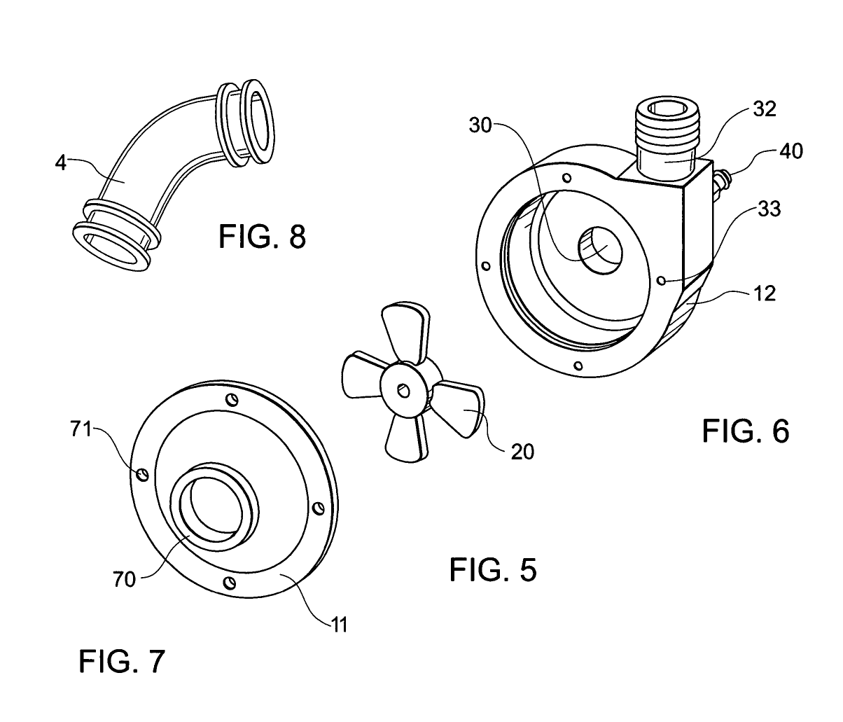

The inventor has found that a four blade fan propeller 20, as shown in FIG. 5, is particularly suitable, although the invention is not limited to this design A typical motor 13 operates at a nominal voltage in the range 6 to 7.2 volts and 1.35 to 1.66 Amps. The following table shows operating characteristics of a typical motor 13. The fan propeller 20 is simply attached to the shaft of motor 13 by press-fit. Other attachment methods such as glue, thread, nut, etc, would also be suitable.

| Volts | Amps | Thrust | Power | Efficiency |
|---|---|---|---|---|
| (V) | (A) | (g) | (W) | (g/W) |
| 6 | 1.35 | 51 | 8.10 | 6.12 |
| 7.2 | 1.66 | 60 | 11.95 | 4.81 |

The shape of the fan chamber 12 is shown in FIG. 6. The chamber is substantially cylindrical and custom-machined to fit closely to the fan blades to achieve maximum air flow. A tight fit between fan and housing means less backdraft so there is more efficient output. Air intake is via the air inlet cone 11 shown in greater detail in FIG. 7. The air inlet cone 11 has an inlet aperture 70 that mates to the air filter 15. In the preferred embodiment this is a simply press-fit arrangement. The cone-shaped internal cavity of the inlet cone 11 assists with air flow through the supercharger. Four bolts (not shown) are used to attach the inlet cone 70 to the fan camber 12 through holes 71 and threaded holes 33.

The fan chamber 12 and inlet cone 11 are preferably made from polished aluminum, which may be anodized in any color, but may be made from other suitable metals as well. They could also be produced from various types of resin such as polycarbonate/ABS alloy, acrylic and polycarbonate.

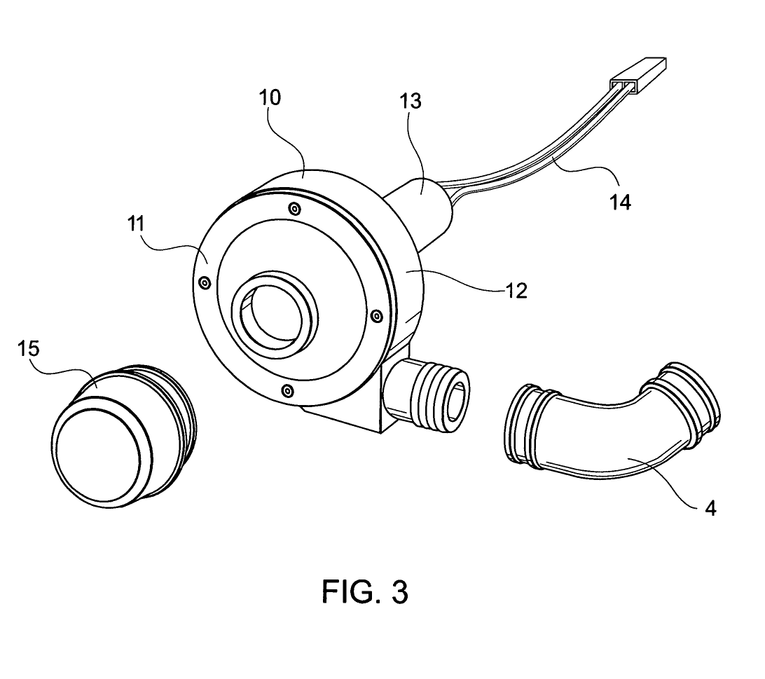

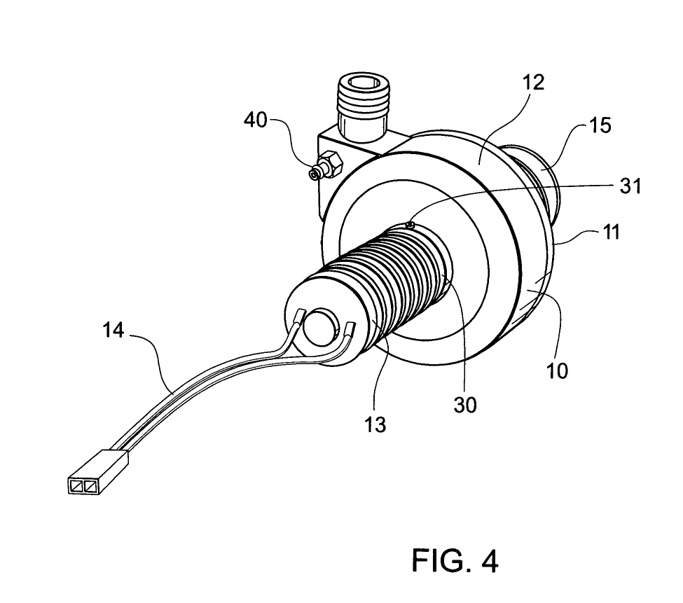

An exit port 32 is a spigot that receives the connector tube 4. Air pressurized by the fan propeller 20 forces air through the exit port 32 and along the connector tube 4 to the carburetor 3. The connector tube may assume a different size and shape from that shown in the figures, for example to allow the components to fit more tightly together. The pressure tube 4 may include a pressure nipple 40, best shown in FIGS. 1 and 4, to bleed off some pressure to the gas tank so that the fuel is pressurized and more fuel can be delivered than via standard gravity feed.

Unlike the prior art, the operation of the supercharger is not linked to the operation of the IC engine. This means that the motor 13 can be started before the IC engine 2 so that the proper air-fuel mixture is available when the engine starts. This is in contrast to the prior art in which the IC engine starts with a rich mix until the engine speed increases sufficiently for the supercharger to be able to generate enough air flow to achieve the correct air-fuel mix.

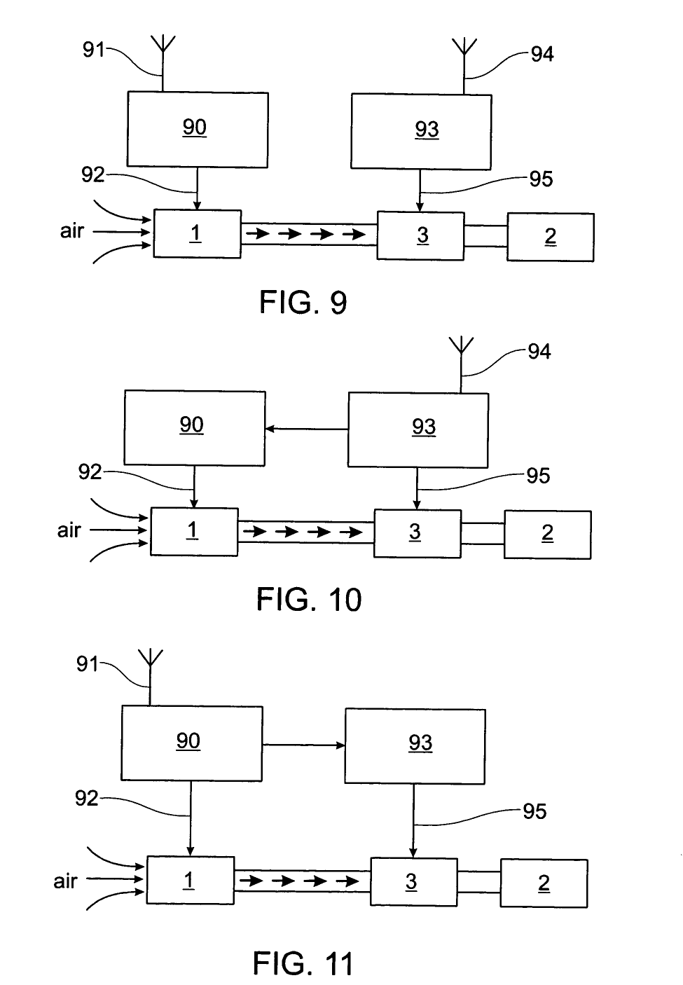

See FIGS. 9-11. The speed of the fan propeller 20 is controlled by an electronic speed controller (ESC) 90. The ESC controls the revolutions per minute of the motor 13, which in turn controls the amount of air provided to the IC engine to ensure a proper air-fuel ratio, and thus provide maximum speed. Unlike the belt driven superchargers or exhaust driven turbochargers of the prior art, the fan speed is variable and independent of the engine speed. This allows the operator to supercharge as much as desired, when needed.

The supercharger can be controlled in a number of different ways, as depicted in FIGS. 9-11. FIG. 9 shows an arrangement to operate the throttle control and ESC independently. The ESC 90 receives radio frequency signals at antenna 91 and converts the signals to speed control signals delivered on line 92 to the supercharger 1. In conventional way, the throttle control 93 receives signals at antenna 94 which are converted to throttle control signals on line 95 to the carburetor 3.

FIG. 10 shows an alternate arrangement wherein the ESC 90 is connected directly to the throttle control 93 so that as the throttle opens up the fan speed increases. This configuration is known as throttle shuttle. In this configuration the supercharger starts at the same time as the IC engine. FIG. 11 shows a configuration similar to FIG. 10 but where the functions of supercharger fan speed control and throttle control are performed by the ESC 90. In this configuration the motor 12 can be started before the IC engine 2.

A particular advantage of the invention is that the supercharger can be fitted to any IC engine since the only required direct connection is the connector tube 4 between the supercharger 1 and the carburetor 3. Using the configuration shown in FIG. 9, there is no requirement for any electrical interaction. The supercharger 1 can be controlled independently from a standard multi-channel radio frequency remote control.

I claim:

1. An electrically powered supercharger for an internal combustion engine of a remote controlled vehicle comprising:
a housing;
a fan propeller located within the housing;
an electric motor for driving the fan propeller mounted to the housing;
an air inlet and an air outlet formed in the housing such that air is urged from the inlet to the outlet by the fan propeller; and
means for controlling the operation of the fan propeller independently of the operation of the internal combustion engine.

2. The supercharger according to claim 1 wherein the means for controlling the operation of the fan propeller comprises an electronic speed controller that controls the speed of the motor in response to remote control signals received from a remote operator.

3. The supercharger according to claim 1 further comprising a battery that provides power to the electric motor via the electronic speed controller.

4. The supercharger according to claim 1 wherein the housing comprises a fan chamber custom machined to fit closely to the fan propeller and an inlet cone.

5. The supercharger according to claim 1 further comprising an air filter fitted to said air inlet.

6. A supercharged internal combustion engine for a remote controlled vehicle comprising:
an internal combustion engine having at least one reciprocating piston and an inlet manifold delivering a fuel-air mixture to a combustion chamber of said at least one piston; and
a supercharger delivering air to the inlet manifold under pressure, the supercharger comprising: a housing;
a fan propeller located within the housing;
an electric motor for driving the fan propeller mounted to the housing;
an air inlet and an air outlet formed in the housing such that air is urged from the inlet to the outlet by the fan propeller; and
means for controlling the operation of the fan propeller independently of the operation of the internal combustion engine.

7. The supercharger according to claim 6 wherein the internal combustion engine includes a carburetor and the supercharger delivers air to the carburetor.

8. The supercharger according to claim 6 wherein the means for controlling the operation of the fan propeller comprises an electronic speed controller that controls the speed of the motor in response to remote control signals received from a remote operator.

9. The supercharger according to claim 8 wherein the electronic speed controller generates throttle control signals to control a throttle of the carburetor.

10. A method of operating a supercharger on an internal combustion engine for a remote control vehicle, the supercharger comprising a housing; a fan propeller located within the housing;
an electric motor for driving the fan propeller mounted to the housing; an air inlet and an air outlet formed in the housing such that air is urged from the inlet to the outlet by the fan propeller; and
means for controlling the operation of the fan propeller independently of the operation of the internal combustion engine;
including the steps of:
supplying a signal to the electric motor to cause it to drive the fan propeller at a speed suitable to provide air to form a correct air-fuel mix for starting the internal combustion engine;
starting the internal combustion engine; and
controlling the electric motor to vary the speed of the fan propeller to effect desired torque/speed characteristics of the internal combustion engine.
